(19) United States
(12) Patent Application Publication
(10) Pub. No.: US 2011/0273773 A1
(43) Pub. Date: Nov. 10, 2011

(54) Three-dimensional Screen Protector

(76) Inventors: Ryan Mongan, Orange, CA (US); Arthur Wu, San Francisco, CA (US); Bryan Lee Hynecek, Redwood City, CA (US); Janet Weis, San Francisco, CA (US)

(21) Appl. No.: 13/100,923

(22) Filed: May 4, 2011

Related U.S. Application Data
(60) Provisional application No. 61/395,025, filed on May 7, 2010.

(51) Int. Cl. G03B 21/56

(52) U.S. Cl. 359/507

(57) ABSTRACT

Screen protectors for electronic devices have been available for some time. Some small touch screen devices have dedicated soft keys on a certain portion of the screen. Soft keys are representations of physical buttons on the screen. Since the devices are generally very small, it is often difficult for the user to avoid accidently hitting one of these soft keys. One application of the invention shows a small ridge that protrudes vertically out of the screen protector, so that the user can feel that under his/her finger/touch, to locate the sections on the screen, e.g. the keyboards or menus and their components. Other variations and examples are also given here.

### RELATED APPLICATIONS

The current application is related to (continuation of) a prior provisional application Ser. No. 61/395,025, filed on May 7, 2010, with the same inventors and assignee, and similar title, taking benefits of all teachings and earlier filing date of that application.

### BACKGROUND OF THE INVENTION

A screen protector is generally used for an electronic device, such as a cell phone, (global positioning system) GPS unit, tablet computer or communication device, game console, hand-held device, PDA (personal digital assistant), e-book reader, texting or email device, or laptop computer. Screen protectors are known in the art to protect the screens of such devices, from inadvertent scratching and scuffing. In addition, for devices that utilize touch screens, the protector keeps skin oil off the screen, keeping them cleaner and more functional. They also help increase longevity and improve performance of such devices.

One embodiment of the invention describes a screen protector which has the unique property of giving the user tactile feedback of where they are on the screen.

### SUMMARY OF THE INVENTION

Screen protectors for electronic devices have been available for some time (FIG. 4). Some small touch screen devices have dedicated soft keys on a certain portion of the screen. Soft keys are representations of physical buttons on the screen. Since the devices are generally very small, it is often difficult for the user to avoid accidently hitting one of these soft keys. For example, when someone is typing on a small screen, they may accidently hit a soft key that takes them out the typing application, altogether. This is frustrating, since the user needs to stop the flow of what they were doing and navigate back to where they were.

One embodiment of the invention shows a small ridge that protrudes vertically out of the screen protector, so that the user can feel that under his/her finger/touch. Other variations are also presented here.

### BRIEF DESCRIPTION OF THE DRAWINGS

FIG. 1 shows an embodiment of the invention, with one horizontal line, or a line parallel to the bottom side of the device.

FIG. 2 shows an embodiment of the invention, with multiple horizontal lines, parallel to each other.

FIG. 3 shows an embodiment of the invention, with multiple horizontal and vertical lines.

FIG. 4 shows a typical screen protector, covering and protecting the screen, on an electronic, communication, entertainment, game, gambling, business, computing, processing, GPS, or mapping device.

### DETAILED DESCRIPTION OF THE PREFERRED EMBODIMENTS

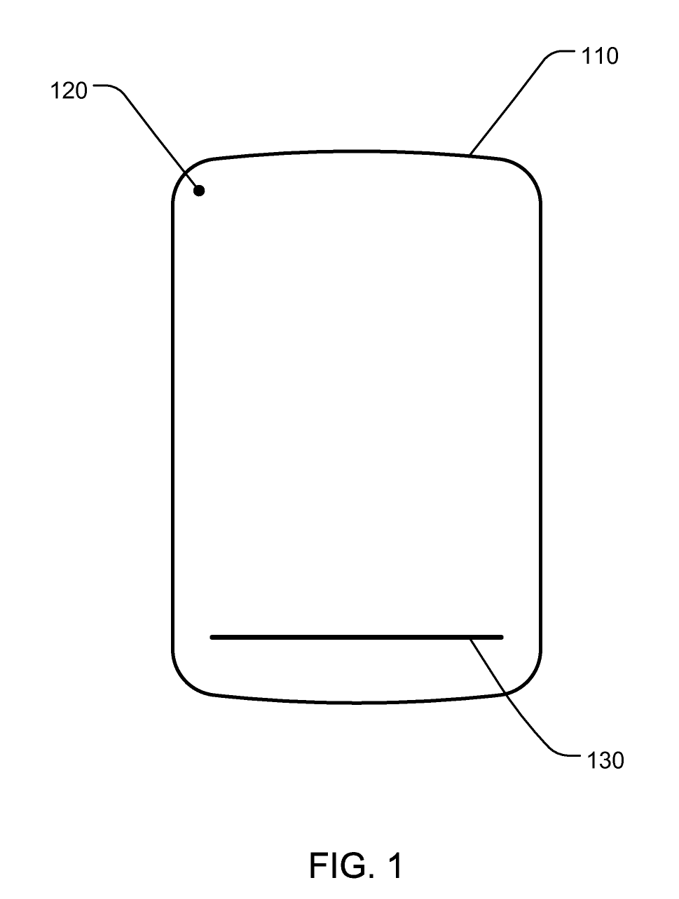

One embodiment of the invention, e.g. as described in FIGS. 1-3, shows a small ridge that protrudes vertically out of the screen protector (120), so that the user can feel that under his/her finger/touch, to make it easier to work with the electronic device, and also to reduce the mistakes in typing and choosing the functions on the menu or from the screen of the device.

Our invention has different variations and types. For example, the marker(s) can be in the shape of dots, lines, circles, crosses, squares, other geometrical shapes and patterns, or any asymmetrical shape or pattern. It can be one marker or multiple (tactile) markers. It can be made of soft, elastic, plastic, or flexible material. Alternatively, it can be made of rigid, solid, or coarse material. In one embodiment, the marker is going inward or lower or down (as a hole, recess, or niche), with respect to the surface of the screen protector. In one embodiment, the marker is going outward or higher or up, with respect to the surface of the screen protector, e.g. as a lip or tongue. In one embodiment, the markers are parallel to each other. In one embodiment, the markers are perpendicular to each other. In one embodiment, the markers are diagonal or crossed with an angle, with respect to each other. In one embodiment, the markers are arrays or matrix of dots or patterns of smaller shapes or objects.

Different materials can be used (e.g. plastic, elastic, transparent, translucent, polymer, touch-sensitive screen or layer, or rubber). One can also replace the protector for different users, depending on preferences, e.g. on the material and color, and size of fingers or hands, for better guiding the fingers and ease of use.

The ridge can be fabricated in a variety of means, including forming out of the screen material itself (e.g. cold forming, thermoforming, hydroforming, explosion forming, etc.), or it can be made of a second material that sits on top of the screen protector. This second material can be applied in various ways (e.g. a sticker, glue, molding, printing of ink, printing of plastic, vacuum, surface tension, using very smooth surfaces, using friction, Velcro-type mechanism, hook-and-loop strap tape, etc.). Tactile feedback can also be accomplished by having the barrier recess into the screen protector. This trough can be created by forming the material as mentioned before. It could also be formed into the material by reducing the thickness of the screen protector locally.

FIG. 1 shows an embodiment of the invention, with one horizontal line (130), or a line parallel to the bottom side of the device (110), as a base line to locate the keys, menu, and functions, with respect to the hand or fingers.

Here are the components of FIG. 1, as an example:

110: Cover. In one embodiment, the cover is dimensioned to cover the exposed screen of the device. In one embodiment, the cover is dimensioned slightly less than the exposed screen size to allow a tolerance for alignment to the screen.

120: Cover material

130: Mark, e.g., bridge, indentation, bump, or curved surface, e.g., in the form of line.

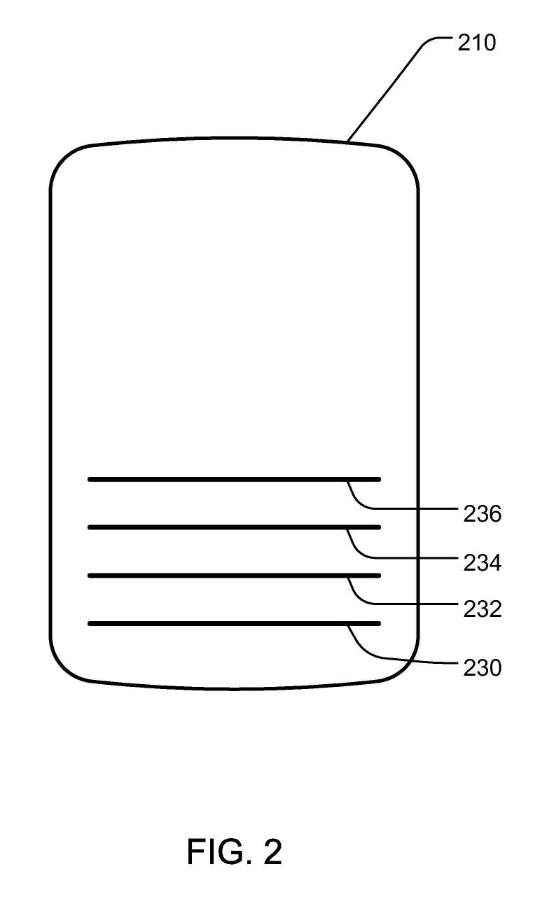

FIG. 2 shows an embodiment of the invention, with multiple horizontal lines, parallel to each other, for locating various items on screen simultaneously, with cross-checking, reducing errors by the user. However, some users may prefer FIG. 1 setup due to simplicity and faster brain adjustment and recognition.

Here are the components of FIG. 2, as an example:

210: Cover

230, 232, 234, 236: Multiple Marks, e.g., bridge or indentation or lip or extension, e.g., in the form of line or curve. In one embodiment, the mark(s) identify the location of soft keyboard row(s) of keys or specific key(s), precisely or roughly.

Note that the multiple lines or markers may have different sizes, thicknesses, depths, feel, material, shape, or heights, to distinguish the main line from the secondary lines or markers, by just the touch and feel of the fingers, to locate and distinguish various regions of the keyboard or menu on the screen.

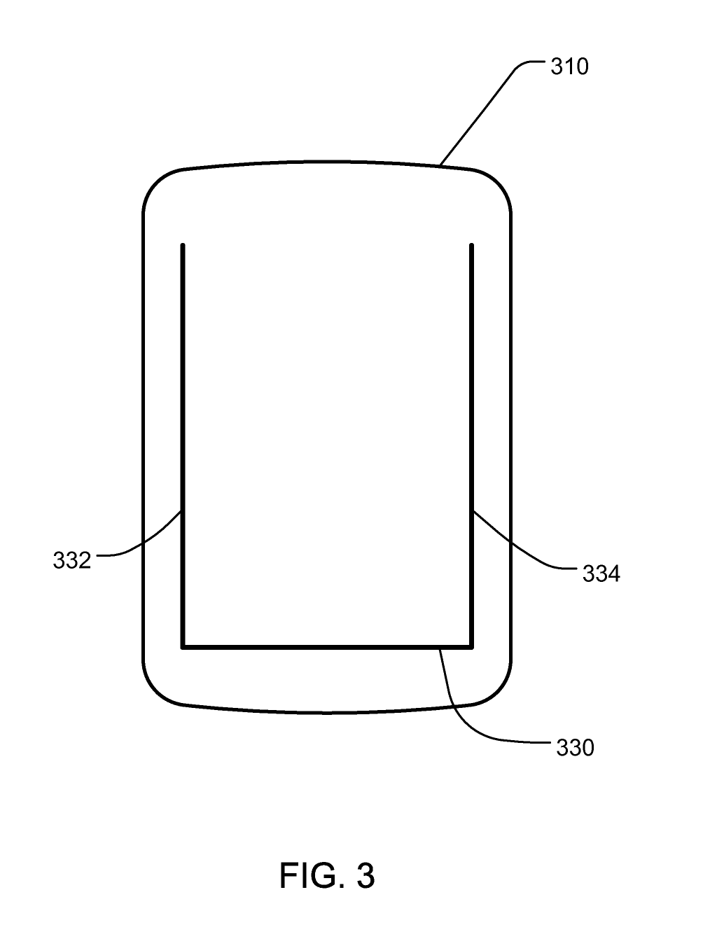

FIG. 3 shows an embodiment of the invention, with multiple horizontal and vertical lines. Other shapes and sizes may also be used, e.g. small crosses at the corners, or dots at the edges, to let the user work with the device e.g. in the low illumination areas or dark places, or with little or no help from eye feedback and observation, mainly depending on the touch and fingers for screen navigations and operations, e.g. GUI or user-interface.

Here are the components of FIG. 3, as an example:

310: Cover

330: Mark, toward the bottom side, e.g., bridge or indentation, e.g., in form of line.

332 and/or 334: Mark(s) toward left and/or right sides. In one embodiment, the mark(s) identify the location of soft keyboard row(s) of keys or specific key(s), or regions on screen.

In various embodiments, the protector can be in one piece or multiple pieces. The protector can be in one layer or multiple layers. The protector can be made of one material or multiple materials. The protector can be in rectangular or square shape, or any other arbitrary shape, for different embodiments. The protector can be thick or thin, or variable thickness, for more user's comfort and handlings.

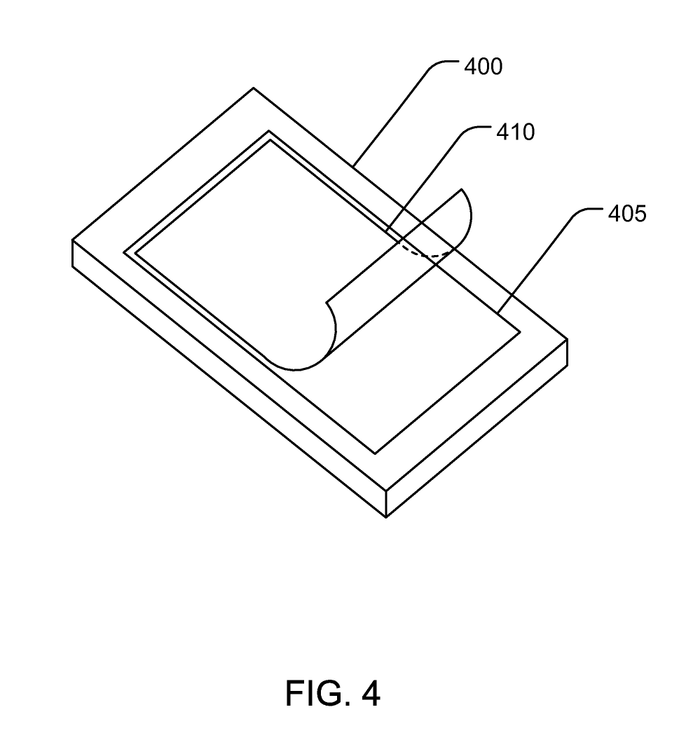

FIG. 4 shows a typical screen protector, covering and protecting the screen, on an electronic, communication, entertainment, game, gambling, business, computing, processing, GPS, global positioning system device, or mapping device.

Here are the components of FIG. 4, as an example:

400: Device with screen, e.g., a Mobile Device

405: Screen

410: Cover, e.g., transparent.

Any variations of the above teaching are also intended to be covered by this patent application.

1. A screen protector which covers a screen of a communication, electronic, entertainment, or computing device, partially or fully, said screen protector comprising:
a flat layer;
one or more tactile markers;
wherein said one or more tactile markers are attached, glued, molded, or structured within said flat layer.

2. The screen protector as recited in claim 1, wherein said one or more tactile markers are made of different materials, compared to that of said flat layer.

3. The screen protector as recited in claim 1, wherein said one or more tactile markers are a single dot.

4. The screen protector as recited in claim 1, wherein said one or more tactile markers are parallel to each other.

5. The screen protector as recited in claim 1, wherein said one or more tactile markers are perpendicular to each other.

6. The screen protector as recited in claim 1, wherein said one or more tactile markers are diagonal to each other.

7. The screen protector as recited in claim 1, wherein said one or more tactile markers are an array of dots.

8. The screen protector as recited in claim 1, wherein said one or more tactile markers are a matrix of dots.

9. The screen protector as recited in claim 1, wherein said one or more tactile markers are a pattern of dots.

10. The screen protector as recited in claim 1, wherein said one or more tactile markers are square shaped.

11. The screen protector as recited in claim 1, wherein said one or more tactile markers are circular shaped.

12. The screen protector as recited in claim 1, wherein said one or more tactile markers are triangular shaped.

13. The screen protector as recited in claim 1, wherein said one or more tactile markers are cross shaped.

14. The screen protector as recited in claim 1, wherein said one or more tactile markers are higher or outward or bulging out, with respect to said flat layer.

15. The screen protector as recited in claim 1, wherein said one or more tactile markers are lower or inward or bulging in, with respect to said flat layer.

16. The screen protector as recited in claim 1, wherein said one or more tactile markers are at different heights, with respect to said flat layer.

17. The screen protector as recited in claim 1, wherein said one or more tactile markers are at different depths, with respect to said flat layer.

18. The screen protector as recited in claim 1, wherein said one or more tactile markers are at different heights, with respect to each other.

19. The screen protector as recited in claim 1, wherein said one or more tactile markers are at different depths, with respect to each other.

20. The screen protector as recited in claim 1, wherein said one or more tactile markers are made of flexible or elastic or expandable material.
